(19) United States
(12) Patent Application Publication
(10) Pub. No.: US 2003/0070074 A1
(43) Pub. Date: Apr. 10, 2003

(54) Method and system for authentication

(76) Inventors: Avner Geller, Tel Aviv (IL); Shay Dardikman, Tel Aviv (IL)

Correspondence Address: FISH & RICHARDSON PC, 225 FRANKLIN ST, BOSTON, MA, 02110, US

(21) Appl. No.: 10/252,962

(22) Filed: Sep. 23, 2002

Related U.S. Application Data
(63) Continuation-in-part of application No. 10/221,930, filed on Sep. 17, 2002.
Application No. 10/221,930 is a 371 of international application No. PCT/IL01/00258, filed on Mar. 18, 2001.

(30) Foreign Application Priority Data
Mar. 17, 2000 (IL) 135150

(51) Int. Cl. H04L 9/32; H04L 9/00

(52) U.S. Cl. 713/168; 713/202

(57) ABSTRACT

Systems and methods for authentication of a user by an identification center are disclosed. A preferred embodiment of the invention includes the transfer over a communication medium of an encryption key to the user and/or the identification center, receipt by the identification center of a password encrypted by the user, simulation by the identification center of the encryption, comparison of the simulated encrypted password(s) with the received encrypted password, and authentication of the user if comparison results are sufficient. In another aspect of the invention, the encryption key is outputted by an identification center terminal and manually inputted into a user terminal.

### CROSS-REFERENCE TO RELATED APPLICATIONS

This application is a continuation-in-part application of and claims priority to U.S. Application Serial No.______, filed on Sep. 17, 2002, which is a national phase application of PCT/IL01/00258 filed Mar. 18, 2001 which claims the benefit of Israel Application Serial No. 135150 filed Mar. 17, 2000.

### FIELD AND BACKGROUND OF THE INVENTION

The present invention relates to a method and system for authentication.

It is a common requirement to verify the authenticity of data, which may represent monetary value or may imply the authenticity of the entity generating that data. Typical applications where authentication is critical to avoid forgery include credit transactions using credit cards or smart cards, online banking, and network log-on. For example, before a credit transaction is undertaken the authenticity of the card and/or transaction value dispensed therefrom must be proved to the authentication system (such as the computer at the credit card center, or the vendor server hosting an e-commerce Internet site), involved in the transaction.

Related art systems for preventing fraudulent use of such systems have included the use of secret identification numbers, known only to authorized system users. These numbers are generally stored on a computer memory associated with a central data processing and communication unit resident at the credit card company computer center, the Internet Service Provider, or the e-commerce vendor server facilities. When an authorized user desires to obtain access to the system, for example to enter into an e-commerce transaction, he must identify himself at the transaction execution terminal, such as a PC connected to the Internet network using IP based communication, by keying his secret identification number or alphanumeric ID string into the terminal. The central data processing unit compares the number keyed by the customer with the stored secret number or ID string corresponding to the customer's account, and if the numbers match, the transaction is authorized.

To impede forgery, the user (for example, the credit card owner) should possess the means to produce authentication elements based partially or fully on the secret number or alphanumeric ID string. This implies that the user must possess some secret. The difficulty in proving authenticity is in providing the means to the authenticator to achieve that proof.

One alternative technique that some systems employ is based on an algorithm driven by a secret key such that a data string processed by the algorithm, results in a secret transformation of that data. The data so transformed is used as an authentication certificate or code, which may be tested by an authenticator. One method of testing involves the authenticator in performing the same secret transformation of the data to yield an authentication certificate, which is compared for equality with that provided by the user (for example, a credit card holder or a smart card).

The underlying concept of this technique is that the authenticator must duplicate the data manipulation by the user so as to compare the result for equality. An element in this technique is that the authenticator must also have knowledge of the key. If several authenticators need to authenticate an entity, each must possess the secret key. The secret key is securely distributed to each potential authenticator prior to the event. This communication solution approach should have the ability to limit authentication capabilities to only those trusted authenticators, which may utilize this function.

Another known alternative technique employs the art of private and public key cryptography wherein an asymmetrical algorithm is used. Public key cryptography is described in the article: Communications of the ACM, vol. 21, No. 2, February 1978, pages 120-126, R. L. Rivest et al. “A Method for Obtaining Digital Signatures and Public Key Crypto-systems”. In this technique, a data element or a change sensitive compression of a data string is enciphered using a secret key or procedure. Authenticity is proven by obtaining the original data element (or change sensitive compression), which is used as a reference value and then using a public key or procedure to decipher the data supplied by the source entity. Equality of the deciphered data with the reference data implies that the secret key or procedure was employed and thus that the data is authenticated.

The use of the concept of a private secret key and a public key for secured communication is described also in U.S. Pat. No. 4,405,829 Rivest, et al. Sep. 20, 1983 “Cryptographic communications system and method”. The system includes a communications channel coupled to at least one terminal having an encoding device and to at least one terminal having a decoding device. A message-to-be-transferred is enciphered to ciphertext at the encoding terminal by first encoding the message as a number M in a predetermined set, and then raising that number to a first predetermined power (associated with the intended receiver) and finally computing the remainder, or residue, C, when the exponentiated number is divided by the product of two predetermined prime numbers (associated with the intended receiver). The residue C is the ciphertext. The ciphertext is deciphered to the original message at the decoding terminal in a similar manner by raising the ciphertext to a second predetermined power (associated with the intended receiver), and then computing the residue, M′, when the exponentiated ciphertext is divided by the product of the two predetermined prime numbers associated with the intended receiver. The residue M′ corresponds to the original encoded message M.

This technique permits any authenticator to know the public key or procedure with which to prove the authenticity of data originating from an entity possessing the complementary secret key or procedure. However, the publicly known procedure must not permit the secret key or procedure to be easily determined.

It is apparent that most present art credit card number based existing transaction arrangements whether cash based, credit card based, or grounded on some derivative transaction arrangement, as exemplified above, fail to provide security confidence for transactions by the purchasing parties in the transaction.

A common problem limiting the public use of electronic based commercial transactions is related to the strong public reluctance from the implementation and direct feeding to the communication network and through it to the computerized authentication system of secret identification numbers such as the credit card ID and security numbers. The limited use of electronic transactions by the average related electronic banking services, credit card, or e-commerce service users, lies in the fact that they do not trust the security and safety of the currently available transaction security support systems.

There is a common fear of users from possible wire-tapping on the communications link associated with a user remote terminal, which can enable the determination of secret identification numbers, corresponding to the customer account numbers.

### SUMMARY OF THE INVENTION

According to the present invention, there is provided a method for authenticating a user by an identification center over a communication medium, comprising: (a) sending via the communication medium an encryption key including at least one element which is required for encrypting a password of the user, wherein the password is presumed to be accessible to the user and to the identification center; (b) the user encrypting the password using at least the encryption key; (c) the user sending the encrypted password via the communication medium; (d) the identification center receiving the encrypted password via the communication medium; (e) the identification center simulating the encrypting on at least one of the passwords accessible to the identification center; (f) the identification center comparing the at least one simulated encrypted password to the received encrypted password; and (g) if results of the comparing are sufficient, the identification center sending via the communication medium an indication that the user has been authenticated.

According to the present invention there is also provided a system for authenticating a user, through a user terminal, by an identification center, through an identification center terminal, the user terminal connected via a communication medium with the identification center terminal, the identification center terminal comprising: (a) a receiver configured to receive an encrypted password via the communication medium from the user terminal or from an intermediate service provider terminal which is also connected via the communication medium, the encrypted password having been encrypted by the user terminal using an encryption key transmitted via the communication medium; (b) a storage configured to store passwords; (c) a simulator configured to simulate the encryption on at least one password from the storage; (d) a comparator configured to compare the at least one simulated encrypted password to the received encrypted password; and (e) a transmitter configured to transmit via the communication medium if the comparison results are sufficient to authenticate the user an indication that the comparison results are sufficient.

According to the present invention there is further provided a system for authenticating a user through a user terminal, by an identification center, through an identification center terminal, the user terminal connected via a communication medium with the identification center terminal, the user terminal comprising: (a) an encrypter configured to encrypt a password using at least an encryption key transmitted via the communication medium; (b) a transmitter configured to transmit the encrypted password to an intermediate service provider terminal which is also connected via the communication medium for transfer to the identification center terminal, or to transmit to the identification center terminal; and (c) a receiver configured to receive, if results of comparing the sent encrypted password with an encrypted password simulated by the identification center terminal are sufficient to authenticate the user, an indication that comparison results are sufficient.

According to the present invention there is provided a method for authenticating a user by an identification center over a communication medium, comprising: (a) the identification center sending via the communication medium an encryption key including at least one element which is required for encrypting a password of the user; (b) the identification center receiving an encrypted password via the communication medium, wherein encryption of the password was performed by the user using at least the encryption key; (c) the identification center simulating the encryption using at least the encryption key on each of less than all passwords accessible to the identification center, the less than all are associated with a preliminary identifier received from the user; (d) the identification center comparing the simulated encrypted less than all passwords to the received encrypted password; and (e) if comparison results of the comparing are sufficient to authenticate the user, the identification center sending an indication that the comparison results are sufficient to authenticate the user via the communication medium.

According to the present invention there is also provided a method for authenticating a user by an identification center over a communication medium, comprising: (a) the identification center receiving a preliminary identifier of the user, the identification center associating the preliminary identifier with less than all passwords accessible to the identification center; (b) the identification center sending via the communication medium an encryption key including at least an n for applying a function Y=X^{e}(mod n) to a password of the user, the user password including at least part of at least one user identification number; (c) if the n differs from all recently sent n to the user, the identification center receiving an encrypted password via the communication medium signifying an approval of the encryption key, wherein encryption of the password was performed by the user using at least the approved encryption key; (d) if the ‘n’ is identical to a recently sent ‘n’ to the user, the identification center receiving a disapproval of the encryption key and repeating (b), (c) and (d); (e) the identification center simulating the approved encryption using at least the approved encryption key on each of the less than all passwords; (f) the identification center comparing the simulated encrypted less than all passwords to the received encrypted password; and (g) if comparison results of the comparing are sufficient to authenticate the user, the identification center sending an indication that the comparison results are sufficient to authenticate the user via the communication medium.

According to the present invention there is further provided a system for authenticating a user through a user terminal, by an identification center, through an identification center terminal, the user terminal connected via a communication medium with the identification center terminal, the identification center terminal comprising: (a) a receiver configured to receive a preliminary identifier of the user and an encrypted user password via the communication medium from the user terminal or from an intermediate service provider terminal which is also connected via the communication medium, the encrypted password having been constructed by the user terminal using at least an encryption key originating from the identification center and transmitted via the communication medium; (b) a storage configured to store at least the password; (c) a simulator configured to simulate the encryption using at least the encryption key on each password in the storage which is associated with the preliminary identifier; (d) a comparator configured to compare each simulated encrypted password and the received encrypted password; and (e) a transmitter configured to transmit via the communication medium if results of the comparator are sufficient to authenticate the user an indication that the comparison results are sufficient.

According to the present invention there is still further provided a system for authenticating a user through a user terminal, by an identification center, through an identification center terminal, the user terminal connected via a communication medium with the identification center terminal, the identification center terminal comprising: (a) a receiver configured to receive a preliminary identifier of the user and an encrypted password via the communication medium from the user terminal or from an intermediate service provider terminal which is also connected via the communication medium, the encrypted password having been constructed by the user terminal using at least an encryption key originating from the identification center and transmitted via the communication medium, the encryption key including at least an n for applying a function Y equals X^{e}(mod n) to the password in order to obtain the encrypted password, the password including at least at least part of at least one user identification number; (b) a storage configured to store at least the password; (c) a simulator configured to simulate the encryption using at least the encryption key on each password in the storage which is associated with the preliminary identifier; (d) a comparator configured to compare each simulated encrypted password and the received encrypted password; and (e) a transmitter configured to transmit via the communication medium if results of the comparing are sufficient to authenticate the user an indication that the comparing results are sufficient.

According to the present invention there is provided a method for authenticating a user by an identification center, comprising: (a) the identification center outputting an encryption key including at least one element which is required for encrypting a password of the user, wherein the password is presumed to be accessible to the user and to the identification center; (b) the user encrypting the password using at least the encryption key; (c) the user inputting the encrypted password to the identification center; (d) the identification center simulating the encrypting on at least one of the passwords accessible to the identification center; (e) the identification center comparing the at least one simulated encrypted password to the inputted encrypted password; and (f) if results of the comparing are sufficient, the identification center outputting an indication that the user has been authenticated.

According to the present invention there is also provided a system for authenticating a user, through a user terminal, by an identification center, through an identification center terminal, the identification center terminal comprising: (a) an input configured to receive an encrypted password, the encrypted password having been encrypted by the user terminal using an encryption key outputted by the identification center terminal; (b) a storage configured to store passwords; (c) a simulator configured to simulate an encryption on at least one password from the storage; (d) a comparator configured to compare the at least one simulated encrypted password to the received encrypted password; and (e) an output configured to output if the comparison results are sufficient to authenticate the user an indication that the comparison results are sufficient.

According to the present invention there is further provided a system for authenticating a user through a user terminal, by an identification center, through an identification center terminal, the user terminal comprising: (a) an encrypter configured to encrypt a password using at least an encryption key outputted by the identification center terminal; (b) an output configured to output the encrypted password; and (c) an input configured to receive, if results of comparing the outputted encrypted password with an encrypted password simulated by the identification center terminal are sufficient to authenticate the user, an indication that comparison results are sufficient, and configured to receive the encryption key.

### BRIEF DESCRIPTION OF THE DRAWINGS

The invention is herein described, by way of example only, with reference to the accompanying drawings, wherein:

FIG. 1 is a block diagram of an authentication system, according to a preferred embodiment of the present invention;

FIG. 2 is a flow chart of a method for authentication according to a preferred embodiment of the present invention;

FIGS. 3A and 3B is a flow chart of a method for authentication, according to another preferred embodiment of the present invention;

FIGS. 4A and 4B is a flow chart of a method for authentication, according to yet another preferred embodiment of the present invention;

FIG. 5 is a block diagram of an identification center terminal, according to a preferred embodiment of the present invention;

FIG. 6 is a block diagram of a user terminal, according to a preferred embodiment of the present invention;

FIG. 7 is a block diagram of an identification center terminal, according to another preferred embodiment of the present invention; and

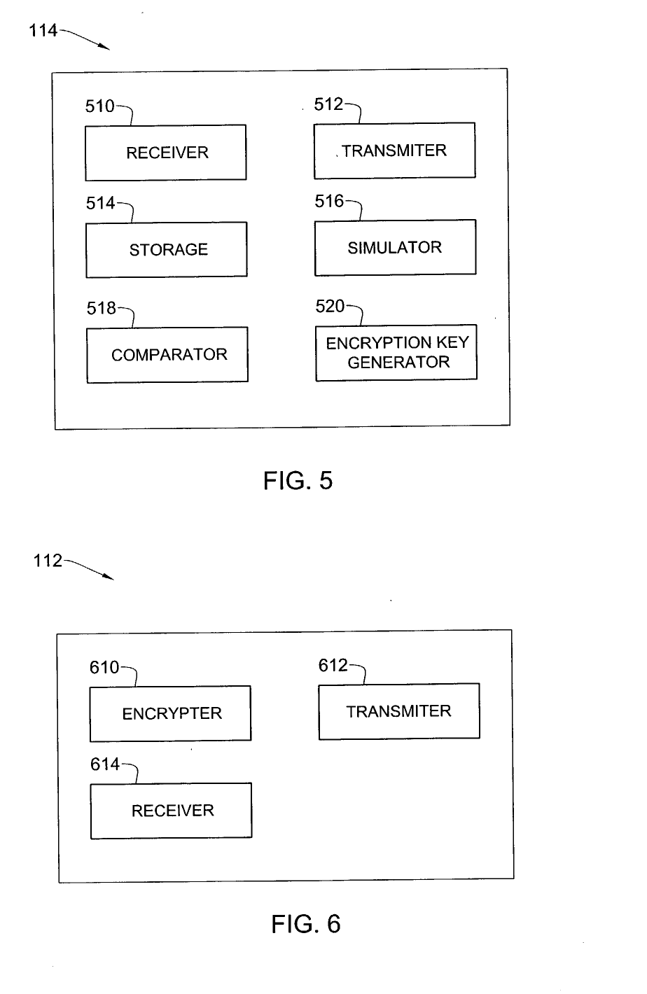

FIG. 8 is a block diagram of a user terminal, according to another preferred embodiment of the present invention.

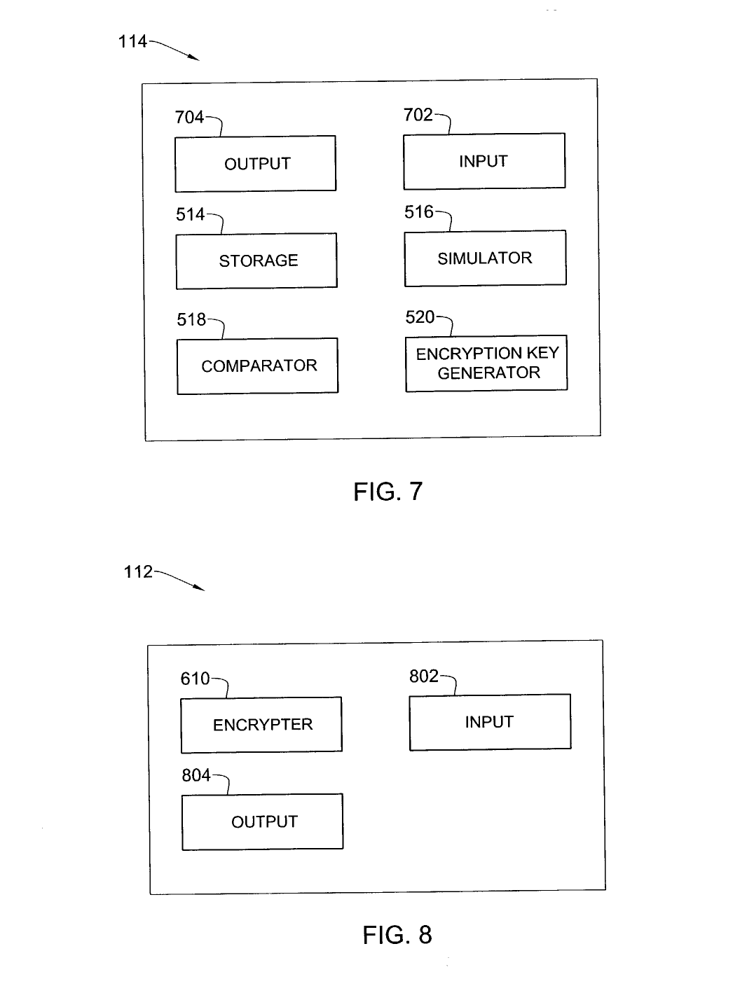

### DESCRIPTION OF THE PREFERRED EMBODIMENTS

A preferred embodiment of the present invention relates to a system and method for authenticating a user over a communication medium. In this preferred embodiment, a predetermined password associated with a particular user is accessible to that user. The predetermined password associated with that particular user is also accessible to the identification center, along with other passwords associated with other users. Various examples of passwords will be discussed in greater detail further below. A password is considered accessible if the password itself can be accessed or if there are accessible means for reproducing the password.

In this preferred embodiment, when authentication of a user is desired, an encryption key is transferred directly or indirectly over a communication medium to the user and/or identification center. The user performs the encryption of his associated password using the encryption key and sends the encrypted password directly or indirectly to the identification center. The identification center simulates the encryption on one or more of the passwords accessible to the identification center and compares each simulated encrypted password to the encrypted password received from the user. The user is authenticated if results of the comparison are sufficient, for example if one of the simulated encrypted passwords is singled out as corresponding to the encrypted password received from the user.

The principles and operation of a system and method for user authentication according to the present invention may be better understood with reference to the drawings and the accompanying description. All examples given below are non-limiting illustrations of the invention described and defined herein.

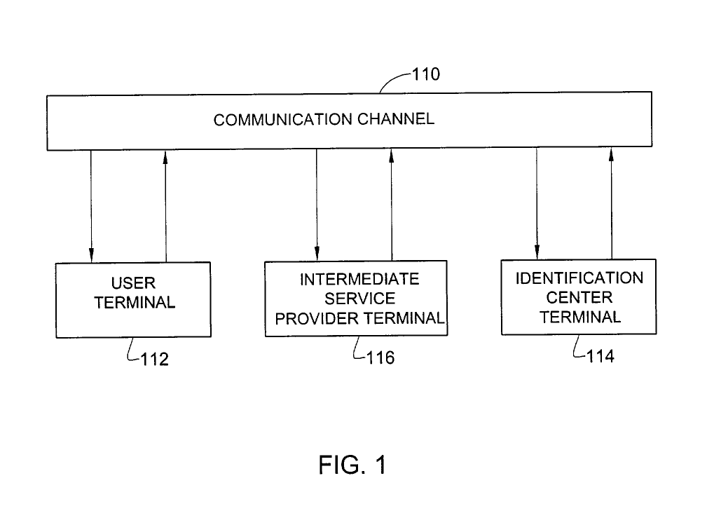

Referring now to the drawings, FIG. 1 illustrates in a schematic block diagram form, an authentication system 100 structured from a communication medium 110 coupled to a user terminal 112, an optional intermediate service provider terminal 116, and an identification center terminal 114, in accordance with a preferred embodiment of the present invention.

Depending on the preferred embodiment, communication medium 110 can represent any combination of physical communication medium with any application protocol. Examples of physical media include, inter-alia: cable, optical (fiber), wireless (radio frequency), wireless (microwave), wireless (infra-red), twisted pair, coaxial, telephone wires, underwater acoustic waves, etc. Examples of application protocols include File Transfer Protocol (FTP), Telnet, Simple Mail Transfer Protocol (SMTP), Hyper Text Transport Protocol (HTTP), Simple Network Management Protocol (SNMP), Network News Transport Protocol (NNTP), Audio (MP3, WAV, AIFF, Analog), Video (MPEG, AVI, Quicktime, RM), Fax (Class 1, Class 2, Class 2.0), tele/video conferencing etc. In some preferred embodiments, communication medium 110 can alternatively or in addition to be identified by the middle layers, with examples including the data link layer (modem, RS232, Ethernet, PPP point to point protocol, serial line internet protocol-SLIP, etc), network layer (Internet Protocol-IP, User Datagram Protocol-UDP, address resolution protocol-ARP, telephone number, caller ID, etc.), transport layer (TCP, Smalltalk, etc), session layer (sockets, Secure Sockets Layer-SSL, etc), and/or presentation layer (floating points, bits, integers, HTML, XML, etc). For example the term “Internet” is often used to refer to a TCP/IP network.

User terminal 112 services the user to be authenticated, providing access by the user to medium 110. For example, user terminal 112 can be inter-alia, a computer, data terminal, or computerized communication device. It should be understood that depending on the embodiment the number of users serviced by a user terminal may vary which may impact the accessibility of the user terminal to a particular user password. For example, in an embodiment where the user terminal is associated with only a small number of users, for example a home computer, the password of the user to be authenticated may be permanently accessible to the terminal, for example stored on the hard drive. Continuing with the example, in an embodiment where the user terminal services a larger number of users, for example if the user terminal is an authentication box at a physical entrance to a restricted place, the password of the user to be authenticated may only be temporarily accessible to the user terminal, for example if the user inserts a card containing her password into the box when authentication is requested.

Identification center terminal 114, providing access by the identification center to medium 110, is associated with an identification center responsible for authenticating the user. For example, identification center terminal 114 can be inter-alia, a bank or a credit card central computer center, or a central access control system for a secured area or secured communication networks.

Intermediate service provider terminal 116 is associated with an intermediate service provider, providing access by the intermediate service provider to medium 110. The term “service provider” should be understood herein below to include providers of both products and services. The term “intermediate service provider” should also be understood to mean one or more entities, at a centralized or dispersed locations. For example, intermediate service provider terminal 116 can be inter-alia a central computer center of the intermediate service provider.

Although it is assumed in the description that the same communication medium 110 is connecting all terminals 112, 114, and optional 116, it should be evident that different communication mediums 110 can connect different pairs of terminals 112, 114, and 116. It should also be evident that terminals 112, 114, and optional 116 can be at any physical distance from one another. For example, terminals 112 and 114 can in one embodiment be connected by a local bus while in another embodiment situated remotely from one another. The present invention is not bound by any specific structure of the terminals, or type of communication medium.

In some embodiments, user authentication is required prior to the identification center or the intermediate service provider executing a transaction related to the user. In some of these embodiments, a transaction number is used to distinguish the transaction. The transaction may be any transaction, for example selling, buying, transferring confidential information, charging a credit/debit card, allowing access to a protected area, allowing exit from a protected area, etc.

A preferred embodiment of the present invention assumes that prior to the authentication process, the user and the identification center had both been provided with the same password associated with the user or with an algorithm to generate the same password (with the identification center having been earlier provided with the passwords and/or algorithms associated with other users as well). For example, the user may have generated the password or an algorithm to generate the password and provided the password or the algorithm (in a suitable format and/or language) to the identification center directly or via the intermediate service provider. As another example, the identification center may have generated the password or an algorithm to generate the password and provided the password or the algorithm to the user directly or via the intermediate service provider. As a third example, in an authentication process which includes an intermediate service provider, the password or an algorithm to generate the password may have been generated by the intermediate service provider and provided to the identification center and the user directly or through one to the other.

Herein below, it is assumed that each user is associated with one password which is accessible to the identification center. However in some applications, a user can be associated with more than one password. In these applications, the identification center may indicate as part of the authentication process which one or more of the user passwords should be encrypted. The indication of which password(s) can be included for example in the encryption key. Continuing with the example, if each user has three associated passwords which are tagged as a, b, or c, the identification center can indicate which password to encrypt by specifying a, b and/or c.

The password associated with a user is in one preferred embodiment constructed from predetermined user identification numbers. For example the password can include inter-alia any combination of all or part of one or more of the following: passport number, driver's license number, social security number, national identification number, birth-date, address, phone number, credit card number etc. Assuming for example that the desired password is a sequence of the following user identification numbers: social security number 1111111, birth date 020202 and zip code 33333 in that order, either the password 111111102020233333 can be provided or an algorithm to generate the password, for example {social security→birth date→zip code} can be provided. In alternative embodiments, the password can include, instead or in addition, one or more digits which are not taken from predetermined user identification numbers but are selected in some other manner. In alternative embodiments, the password may include characters which are not digits, for example letters, special characters, etc. The non-digit characters may be taken from predetermined user identification (for example, name, mother's maiden name, city of birth, etc.) or may be selected in some other manner.

A feature of a preferred embodiment of the present invention is the transmission of at least one encryption key which defines or completes the definition of the encryption to be applied to the user password (and possibly during simulation to other passwords accessible to the identification center). In other words the transmitted encryption key includes at least one element needed to perform the encryption. For example, assuming the encryption includes applying a function to the password, the encryption key could include at least one element required for applying the function to the password(s).

Optionally a preliminary identifier is transmitted to the identification center which is used by the identification center to select from list of all the passwords accessible by the identification center those passwords corresponding to the preliminary identifier on which simulation is to be performed, thereby speeding up the encryption simulation process. The preliminary identifier used can reduce the number of passwords to be encrypted in the simulation substantially or minimally. For example, if the preliminary identifier is unique to an individual, such as a social security number, the number of passwords to be encrypted in the simulation is one or zero, depending on whether the social security number corresponds to one of the users whose password is accessible to the identification center. As another example, if the preliminary identifier is the year of birth of the user, there would typically be a plurality of passwords on which encryption would need to be simulated, corresponding to all users born in that year whose passwords are accessible to the identification center.

In some embodiments, the preliminary identifier can be related to the password so that knowledge of the preliminary identifier can help in determining the password, for example a preliminary identifier including less than all of the characters in the password, or a preliminary identifier resulting from a transformation of the password. In other embodiments, the preliminary identifier can be unrelated to the password so that knowledge of the preliminary identifier does not help in determining the password. In still other embodiments, the preliminary identifier can be independent of the password (i.e. the choice in preliminary identifier does not take into account whether the preliminary identifier is related or unrelated to the password).

The same preliminary identifier can be used always or there may be more than one preliminary identifier which is randomly or otherwise used each time the same user wishes to be authenticated.

Examples of preliminary identifiers include inter-alia: year of birth of the user, date of birth of the user, part of a social security number of the user (for example last four digits), a social security number of the user, the expiry month and year of a credit card of the user, less than all the characters in the password of the user (for example the first few characters), a predetermined number of letters and along with a predetermined number of digits, a personal identification number PIN of the user, name of the user, part or all of a credit card number of the user, part or all of a national identification number of the user, part or all of a passport number of the user, part or all of a driver's license number of the user, part or all of a telephone number of the user, part or all of an address of the user, city of birth of user, maiden name of mother of user, etc.

If no preliminary identifier is used, then each password accessible to the identification center which corresponding to a different user is preferably different so as to allow authentication of each user on a separate basis.

If a preliminary identifier is used to select a group of corresponding passwords, then each password in the group should preferably be different so as to allow authentication of each user in the group on a separate basis. Passwords, each of which belongs to a different group as defined by the used preliminary identifier would not necessarily need to be constrained to be different. For example, if the preliminary identifier is the city of birth of the user, then preferably all users born in a given city would have a different password, but more than one user, each born in a different city, can optionally have the same password.

Alternatively, in an application where users belonging to the same group identified by the preliminary identifier do not need to be separately authenticated, all or some of the users may have the same password. For example, if the preliminary identifier identifies a department in a company, all members in the department may share a password which allows access to group file archives.

In the case of a preliminary identifier which is unique to a user, each password accessible to the identification center does not necessarily need to be different because the preliminary identifier pinpoints one password at the identification center which is encrypted and compared to the received encrypted password. For example, if the preliminary identifier is the unique credit card number of the user and the password is similar to the commonly used personal identification number PIN (for example including 4 to 6 characters), more than one user may in some cases be associated with the same PIN, without lowering the level of authentication reliability compared to a unique PIN for each user.

It should be noted that even if two passwords are different, a particular encryption applied to the two passwords may cause the two encrypted passwords to be identical. Therefore in some cases, more than one encryption round (see below) may be required to authenticate the user.

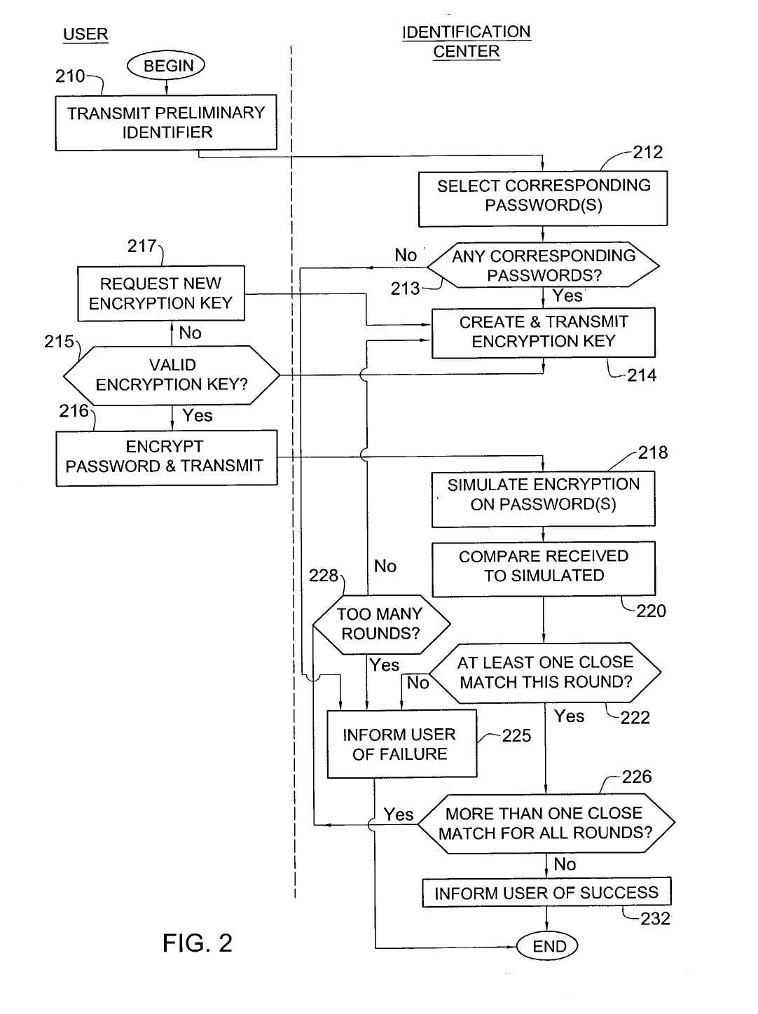

FIGS. 2 through 4 illustrate exemplary preferred embodiments of a method of authenticating a user. The invention is not bound by the specific steps or order of the steps illustrated and discussed with reference to these figures. It should also be noted that alternative embodiments can include selected steps from two or more of the illustrated embodiments. Other embodiments are also applicable, all depending on the particular application.

FIG. 2 is a flow chart of the steps of an authentication method of a preferred embodiment of the present invention. In optional step 210, the user transmits a preliminary identifier to the identification center. In optional step 212, the identification center uses the received preliminary identifier to select all passwords corresponding to the preliminary identifier. Steps 210 and 212, when performed allow a faster simulation process (see below step 218) because of the reduced number of passwords to process. In optional step 213, the identification center checks that the preliminary identifier corresponds to at least one password. If not, the user is informed of failure (step 225). The preliminary identifier may not correspond to any passwords, for any number of reasons such as for example, if the preliminary identifier is incorrect (faulty entering) or the preliminary identifier is fraudulent. If at least one corresponding password is selected, or if steps 210, 212, and 213 were omitted then in step 214, the identification center creates and transmits an encryption key.

In optional step 215, the user verifies that the encryption key is valid and if not the user transmits a request for a new encryption key to the identification center in optional step 217. Step 215 is omitted for example if either the encryption key is always assumed to be valid or if the user does not have the means to check the validity of the encryption key. Provided the encryption key is valid or step 215 is omitted, in step 216, the user encrypts the password and transmits the encrypted password to the identification center.

In step 218, the identification center simulates the encryption on all the accessible passwords or if steps 210 and 212 were performed then on all the passwords selected in step 212. In step 220, the identification center compares each simulated encrypted password to the received encrypted password. If there is not at least one close enough match, the authentication fails and the user is notified of the failure in step 225. If there is more than one close enough match, another encryption key is created and transmitted in step 214 and the subsequent steps are repeated (i.e. a new round) in order to find a single close enough match common to the encrypted passwords received in all the rounds of the current authentication process. On any repetition of step 226 the evaluation is whether there is more than one common close enough match for all encrypted passwords received in the current authentication process with the user. If the identification center either in the first round or in subsequent rounds of the session, finds a single close enough match, then the authentication succeeds and the user is notified of the success in step 232.

The authentication may also fail (step 228) if there are too many rounds. Depending on the application, more than one round may be considered too many so that if there is more than one close enough match, the process may conclude with an authentication fail rather than performing more rounds. In other applications, more than a predetermined number of rounds may be considered too many or the number of allowed rounds may be unlimited. A limitation on the number of rounds would typically although not necessarily limit the maximum computation time spent by the identification center in authenticating a user, and may also prevent a problematic endless loop (which may occur for example, if the preliminary identifier corresponds to two or more users with identical passwords which are accessible to the identification center).

Many variations of the method are possible depending on the preferred embodiment. For example, step 214 can be executed by the user who generates the encryption key and transmits the encryption key to the identification center. As another example, if in step 212 the number of selected corresponding passwords is considered too large for the given application, an additional preliminary identifier may be requested and received by the identification center in order to further reduce the number of selected corresponding passwords. As another example, steps 210 and 216 can be combined with the user sending the preliminary identifier and the encrypted password closely in time and the identification center performing steps 212 and 213 after receiving the preliminary identifier. As another example, if a transaction is involved, a transaction number (including herein below any other type of transaction identifier) may be used to distinguish a transaction and/or indication of execution of the transaction by the identification center may serve to inform the user of success in step 232. As another example, if there is more than one close enough match, instead of performing another round, criteria may be applied to choose one out of the more than one close enough matches. Other variations are possible depending on the particular implementation.

In another preferred embodiment, the authentication method also involves an intermediate service provider. Preferably, there is an enrollment procedure. For example, prior to beginning the steps to authenticate the user, either at the beginning of the current authentication process or during a previous interaction between the user and the intermediate service provider, the user submits identifying enrollment information and the intermediate service provider assigns a customer identifier to the user which is used to distinguish the user in all subsequent interactions with the intermediate service provider. The submitted enrollment information is typically but not necessarily tailored to the needs of the particular intermediate provider. Examples of enrollment information include inter-alia one or more of the following: name, address, telephone number, birth-date, etc. The enrollment procedure is known in the art and will therefore not be further elaborated on

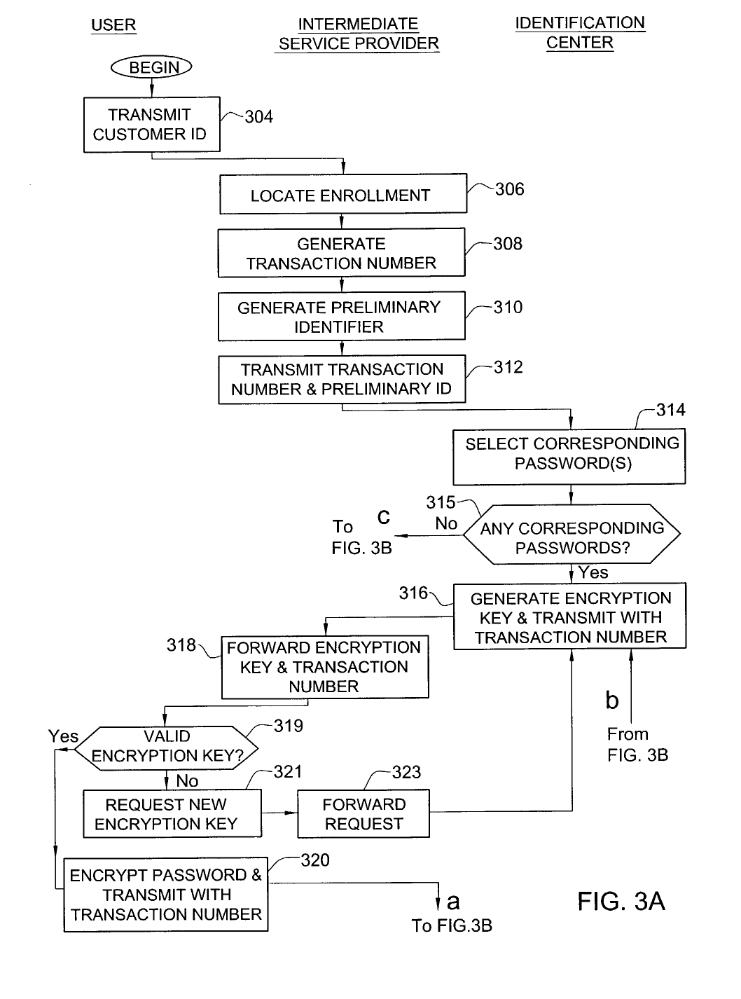

FIG. 3 illustrates one preferred embodiment of a method including an intermediate service provider who requires authentication of the user prior to performing a transaction. It is assumed in FIG. 3 that enrollment has previously taken place. In step 304, the user transmits the assigned customer identifier to the intermediate service provider. In step 306, the intermediate service provider locates the enrollment information based on the received customer identifier of the user. In step 308, the intermediate service provider generates a transaction number to identify the current transaction. In optional step 310, the intermediate provider generates a preliminary identifier, for example based on the enrollment information. In step 312, the intermediate provider transmits the transaction number and optionally the preliminary identifier to the identification center. In optional step 314, the identification center uses the received preliminary identifier to select all passwords corresponding to the preliminary identifier. Steps 310 and 314, when performed allow a faster simulation process (see below step 324) because of the reduced number of passwords to process. In optional step 315, the identification center checks that the preliminary identifier corresponds to at least one password. If not, the identification fails (step 330). The preliminary identifier may not correspond to any passwords, for any number of reasons such as for example, if the preliminary identifier is incorrect (faulty entering) or the preliminary identifier is fraudulent.

If at least one corresponding password is selected, or if steps 310, 314, and 315 were omitted, then in step 316, the identification center generates an encryption key and transmits the encryption key along with the transaction number to the intermediate service provider for forwarding to the user in step 318. In optional step 319, the user verifies that the encryption key is valid and if not the user requests a new encryption key in optional step 321 (The request is transmitted to the intermediate service provider which forwards the request to the identification center in optional step 323). Step 319 is omitted for example if either the encryption key is always assumed to be valid or if the user does not have the means to check the validity of the encryption key. Provided the encryption key is valid or step 319 is omitted, in step 320, the user encrypts the password and transmits the encrypted password along with the transaction number to the intermediate provider. In step 322, the intermediate provider forwards the encrypted password and the transaction number to the identification center.

In step 325, the identification center simulates the encryption on all the accessible passwords or if steps 310 and 314 were performed then on all passwords selected in step 314. In step 326, the identification center compares the received encrypted password to the simulated encrypted passwords. If there is not at least one close enough match, the identification center sends to the intermediate provider the transaction number along with an indication of authentication failure in step 330. The user is informed of denial of the transaction in step 332. If there is more than one close enough match, another encryption key is generated in step 316 and the subsequent steps are repeated (i.e. a new round) in order to find a single close enough match common to the encrypted passwords received in all the rounds of the current authentication process. On any repetition of step 334, the evaluation is whether there is more than one common close enough match for all encrypted passwords strings received in the current authentication process with the user. If the identification center either in the first round or in subsequent rounds of the authentication process, finds a single close enough match, then the transaction number along with an indication of authentication success is sent to the intermediate service provider in step 336.

The intermediate service provider performs the corresponding transaction in step 338. In step 340, the user receives an indication of transaction execution. The authentication may also fail (step 335) if there are too many rounds. Depending on the application, more than one round may be considered too many so that if there is more than one close enough match, the process may conclude with an authentication fail rather than performing more rounds. In other applications, more than a predetermined number of rounds may be considered too many or the number of allowed rounds may be unlimited. A limitation on the number of rounds would typically although not necessarily limit the maximum computation time spent by the identification center in authenticating a user, and may also prevent a problematic endless loop (which may occur for example, if the preliminary identifier corresponds to two or more users with identical passwords which are accessible to the identification center)

Many variations of the method including the intermediate provider are possible depending on the preferred embodiment. For example, if no transaction is involved, steps in the method of FIG. 3 relating to the transaction and transaction number may be omitted. As another example, the user can generate the encryption key and transmit the encryption key along with the transaction number to the intermediate service provider for forwarding to the identification center. As another example, the computational requirements of the intermediate service provider can be reduced if step 310 is omitted and for example in step 304, the user transmits the preliminary identifier to the intermediate service provider for forwarding to the identification center, or in step 320 the user sends the preliminary identifier along with the encrypted password. On the other hand the computation requirements of the intermediate service provider can be increased if the intermediate service provider rather than the identification center generates the encryption key and transmits the encryption key along with the transaction number to both the identification center and the user As another example of a possible variation for a preferred embodiment, if in step 314 the number of selected corresponding passwords is considered too large for a given application, an additional preliminary identifier may be requested and received by the identification center in order to further reduce the number of selected corresponding passwords. As another example, if there is more than one close enough match, instead of performing another round, criteria may be applied to choose one out of the more than one close enough matches. Other variations are possible depending on the particular implementation.

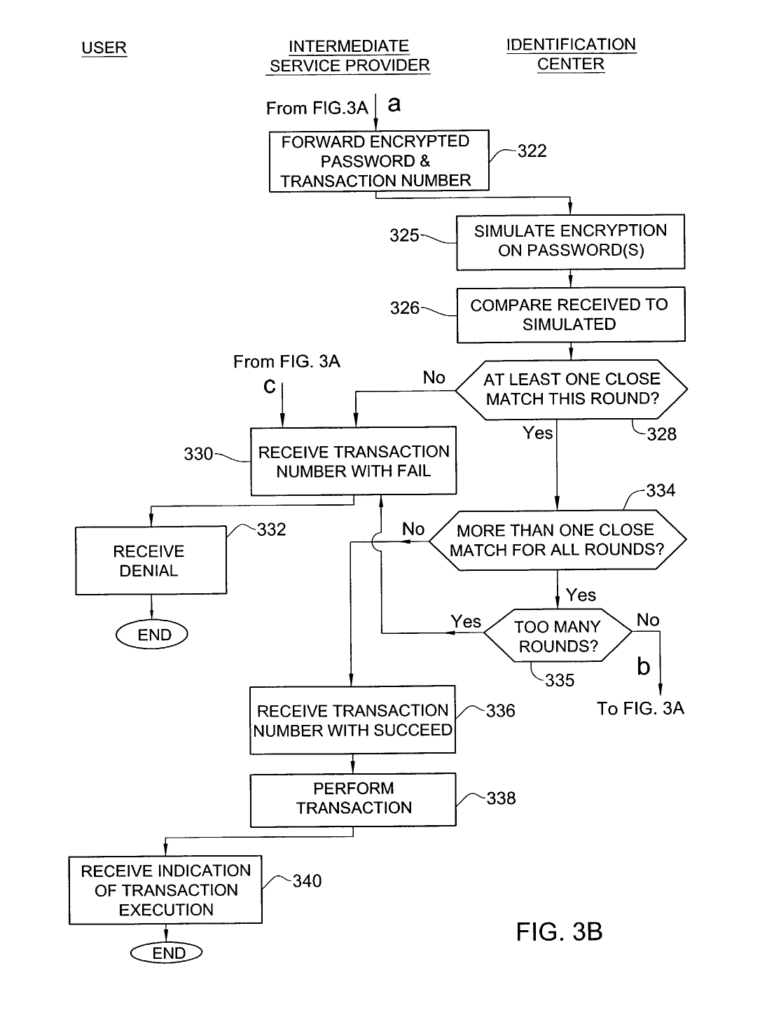

In another preferred embodiment of the authentication process illustrated in FIG. 4, a three way line of communication may be established so that the user can communicate both with the intermediate provider and with the identification center.

It is assumed in FIG. 4 that enrollment has previously occurred. In step 430, the user transmits the assigned customer identifier to the intermediate service provider. In step 432, the intermediate service provider generates a transaction number and transmits the transaction number to the user. In optional step 434, the user generates a preliminary identifier. In step 436 the user transmits the transaction number and optionally the preliminary identifier to the identification center. In optional step 437, the identification center uses the received preliminary identifier to select all passwords corresponding to the preliminary identifier. Optional steps 434 and 437, when performed allow a faster simulation process (see below step 447) because of the reduced number of passwords to process. In optional step 438, the identification center checks that the preliminary identifier corresponds to at least one password. If not, the authentication fails (step 452). The preliminary identifier may not correspond to any passwords, for any number of reasons such as for example, if the preliminary identifier is incorrect (faulty entering) or the preliminary identifier is fraudulent.

In step 439, the identification center generates m encryption keys and send j out of m encryption keys to the intermediate provider along with the transaction number, and k out of m encryption keys directly to the user along with the transaction number (where, m≧1 and j+k=m). The m encryption keys may all be the same, all different, or some may be the same and some may be different. For example, in one possible embodiment each of the j encryption keys is identical to one of the k encryption keys. In step 440, the intermediate service provider forwards the j encryption keys and the transaction number received from the identification center to the user. In step 442, the user receives the m encryption keys and the transaction number.

Optionally (not shown), the user can verify if all the encryption keys are valid, and if not request a substitute set of m keys, request a substitute set of j keys (if any of the j keys are invalid), request a substitute set of k keys (if any of the k keys are invalid), request substitute keys for any invalid keys, or discard any invalid keys without substitution. Validation of each received encryption key can be performed independently of other encryption keys received in the same round in step 442 and/or in relation to other encryption keys received in the same round. Independent validation of a key can be for example with respect to security requirements as will be discussed further below. In a particular embodiment where each k key should match a j key, validation with respect to other keys received in the same round would include checking if each j key has a corresponding k key. In the remainder of the description of the illustrated embodiment in FIG. 4, it is assumed that either the user does not verify the encryption keys or that the verified encryption keys are all valid. In step 444, the user encrypts the password using the m encryption keys and transmits the corresponding m encrypted passwords and transaction number, of which k are transmitted directly to the identification center and j are transmitted to the intermediate service provider. The intermediate service provider forwards the j received encrypted passwords and the transaction number to the identification center in step 446. In step 447, the identification center simulates the m encryptions for each password accessible to the identification center, or if steps 434 and 437 were performed then on all passwords selected in step 437.

In step 448, the identification center compares each set of simulated m encrypted passwords with the set of received m encrypted passwords. If there is not at least one close enough match for all m received encrypted passwords then in step 452, the identification center transmits the transaction number and an indication of authentication failure to the intermediate service provider and the user. If there is more than one close enough match, another m encryption keys are generated in step 439 for a new round (where m this round may or may not equal m in any previous round) and the subsequent steps are repeated in order to find a single close enough match common to all received sets of m encrypted passwords. On any repetition of step 454 the evaluation is whether there is more than one common close enough match for all sets of m encrypted passwords received in the current authentication process with the user.

If the identification center either in the first round or in subsequent rounds of the identification process finds a single close enough match, then the transaction number along with an indication of authentication success is sent to the intermediate service provider and to the user in step 456.

The intermediate service provider performs the corresponding transaction in step 458 and informs the user of performance of the transaction in step 460. The authentication may also fail (step 455) if there are too many rounds. Depending on the application, more than one round may be considered too many so that if there is more than one close enough match, the process may conclude with an authentication fail rather than performing more rounds. In other applications, more than a predetermined number of rounds may be considered too many or the number of allowed rounds may be unlimited. A limitation on the number of rounds should typically although not necessarily limit the maximum computation time spent by the identification center in authenticating a user, and may also prevent a problematic endless loop (which may occur for example, if the used preliminary identifier corresponds to two or more users with identical passwords which are accessible to the identification center. )

Many variations of the method of FIG. 4 are possible depending on the preferred embodiment. For example, if no transaction is involved, steps in the method of FIG. 4 relating to the transaction and transaction number may be omitted. As another example, step 434 can be omitted and in step 432, the intermediate provider can generate the preliminary identifier for example based on the enrollment information and transmit the preliminary identifier and the transaction number to the identification center. As another example, in step 456, an indication of success may be transmitted only to the intermediate service provider and the indication of transaction performance in step 460 may suffice to inform the user that the authentication process was successful. As another example, if in step 437 the number of selected corresponding passwords is considered too large for a given application, an additional preliminary identifier may be requested and received by the identification center in order to further reduce the number of selected corresponding passwords. As another example, the preliminary identifier can be transmitted along with the encrypted password in step 444 with the identification center performing steps 437 and 438 after receiving the preliminary identifier. As another example, less than all valid encryption keys may be used for the encryption. As another example, if there is more than one close enough match, instead of performing another round, criteria may be applied to choose one out of the more than one close enough matches. Other variations are possible depending on the particular implementation.

In order to enhance the security of the authentication process, one or more of the following criteria may be optionally implemented in a particular preferred embodiment.

First, the number of potential passwords (i.e. passwords which qualify for association with users) may be made sufficiently large to defy a brute force attack of encrypting all potential passwords among which there is at least one valid encrypted password (i.e. matching an actual encrypted password accessible to the identification center which is associated with a user).

Second, the actual passwords (i.e. the passwords which in reality are associated with users) that are accessible to the identification center should be kept secret and/or the correspondence between actual passwords and potential passwords should be kept secret. If the actual passwords and/or the correspondence are not kept secret, a large number of potential passwords will not impede an attacker who can instead focus on the actual passwords.

Third, the encryption can include applying a one-way function, i.e. a function which is easy to calculate in one direction but difficult to calculate the inverse in the reverse direction. In this case, even if an eavesdropper eavesdrops one or more sets of the encryption key and encrypted password, it would still be difficult for the eavesdropper to compute or impersonate the password.

Fourth, the encryption can include applying a many to one function, so that attempts by an eavesdropper at inverting an eavesdropped encrypted password may possibly lead to more than one password (and then the eavesdropper would still have to determine which of those passwords corresponds to the particular user). If the “many” is small, the eavesdropper may use some trial and error, but if the function is heavily many to one, trial and error is less feasible.

Fifth, the preliminary identifier may be required to be unrelated to the corresponding password so that knowledge of the preliminary identifier does not help in determining the password. One or more of the specified exemplary five conditions (and/or other conditions instead of or in addition to the specified five conditions) can be used depending on the particular implementation.

Assume for the sake of the example that the encryption is based on applying the common finite field exponentiation operation Y=X^{e}(mod n) to the password, the password assumed to include only numeric characters. Assume, for example that this function is used to encrypt a password X and that the elements transmitted in the encryption key include n, e and optionally the function definition (e.g. ‘residue of division by n of X raised to the power e’) so that the function Y can be calculated by substituting the password for X. As another example, if the same function is assumed to be used to encrypt a password e, then X, n and optionally the function definition can be transmitted in the encryption key so that the function Y can be calculated by substituting the password for e.

It should be noted that usage of this exemplary function complies with security criteria listed above, provided that n and e are properly chosen (see below). Y=X^{e}(mod n) is a one-way function. Therefore, simulation of the function is particularly expedient compared to attempting to calculate the inverse. The calculation of Y using X, n, and e is much easier than trying to calculate X (or e whichever be the case) from Y, n, and e (or X whichever be the case). Also, Y=X^{e}(mod n) is a many to one function, i.e. more than one X (or e whichever be the case) may result in the same Y. In addition, the minimum length of the password can be selected so that the number of potential passwords thwarts a brute force attack. To give some insight, the following example is provided. The operation of exponentiation required to verify one potential password has been evaluated empirically to allow efficiently for 20 such verification tests per second. Assume however for the sake of example that a genius attacker can perform 330 such tests per second today. Assume also a conservative modification of Moore's law under which computer efficiency doubles every two years, thus implying that in twenty years from now, speed will be 1000 times higher—see Silverman, R. D, (2000), a cost based security analysis of symmetric and asymmetric key lengths, RSA Laboratories/Bulletins/Bulletin #13. This would imply that 1000 processors working in parallel in twenty years from now will try in a year (recall: 3×10⁷ seconds per year) about 10¹⁶ (i.e.. 1000*1000*3*10⁷*330) potential passwords. Therefore, for a particular application which would consider a system “secure” if a successful attack would require a year of attempts, twenty years from now, the password should preferably be at least 16 digits long. For example, such an application may use a password of e.g. 20 digits long.

Continuing with the example of the function Y=X^{e}(mod n), in order to further hamper any attempt to compute the password (assumed here to be X) using eavesdropped encryption keys (each encryption key assumed to at least include one pair of n and e), one or more of the following extra precautions may be optionally implemented in a particular preferred embodiment.

First, n can be generated as the product of two randomly generated prime numbers p and q (alternatively, p and q can be judged to be prime with high probability). The factors p and q are preferably of similar size so as to deter brute force attacks. Note that the smaller of the two factors, p and q, determines the complexity of a brute force attack, so by making p and q of comparable size, the smaller of the two factors is as big as can be and safety is maximal. Preferably n (and therefore the encrypted password) are at least e.g. 200 decimal digits long, so that factoring n is extremely difficult if not impossible.

Second, the probability should be minimized of eavesdropping more than once the same n (with the same or different e) along with the corresponding encrypted password(s) corresponding to the same password. If the same pair (n,e) is used to encrypt the same password more than one time, in subsequent times an eavesdropper can just transmit to the identification center the encrypted password, eavesdropped during a previous time, which would be accepted as legitimate. If the same n is used more than once to encrypt the same password, each time paired with a different e, it can be shown that it is mathematically possible for an eavesdropper to determine the password or a variable connected to the password from the more than one eavesdropped pairs of [n,e₁; n,e₂; . . . ] and the encrypted passwords corresponding to the pairs.

If a new many digit n is always generated for each encryption key, the probability is inherently minimized because the probability of ever generating twice the same value of n is practically negligible. Alternatively, if it is considered too time consuming to generate a proper n each time an encryption key is required, and if it is assumed that the identification center generates the encryption key, then the identification center can keep in a buffer a sample of tens or hundreds of recently generated n values and pick one at random for each encryption key. In this case the user would check the validity of the received encryption keys. For example, assuming a particular user always encrypts the same password, the user could keep a record of recently used n's (possibly along with other information such as recently used e's). In this example if a received encryption key includes an n that is identical to one of the n's in the record, the user disapproves the received encryption key, either ignoring the disapproved encryption key and using any remaining sent encryption keys or requesting a replacement encrypted key or set(s) of encryption keys. The probability that the user would need to disapprove the received encryption key depends on the frequency in which the user applies for authentication, and the frequency of generation of new n. For example, assume that a user applies for authentication every m=3600 seconds (i.e. every hour on average) and a new n is generated every k=10 seconds, then the probability of failure per trial, k/m, is less than 3 in a thousand. For optimal performance, the record of recently used n's would be stored by the user for at least the amount of time required to empty a full buffer at the identification center.

Third, e should be sufficiently large so that X^{e} wraps around the size of n, at least a few times. Note that finding the regular root of a number is feasible whereas finding the modulo n root of a number is currently considered intractable. Therefore e should be sufficiently large so that modulo n is significant in the function X^{e}(mod n) and the function does not reduce to X^{e}. For example, assuming X is of 16 digits length and n is 200 digits long, an e of e.g. 50 would result in an X^{e} of 800 digits long, which is four times longer than the length of n. A larger e would also minimize the probability of repeating the use of the same e for encrypting the same password. On the other hand, the size of e should take into account computational requirements. As e becomes larger, the time to compute the encryption increases. Therefore, in some applications where encryption time is desired to be kept short, the size if e may be kept close to the minimum dictated by the wrapping around requirement.

Fourth, the probability or using the same factor p and/or q more than once for encrypting the same password should be minimized. Reusing p or q to produce more than one n may lead to discovery of the reused p or q, for example by calculating the greatest common denominator of the produced n's, and consequently the discovery of the other factor, for example through division of a produced n by the discovered reused factor. Therefore, the same p and/or q should not be reused on purpose, for example in order to save computation time. However, because p and q are very large primes (or judged to be prime with a high probability), the probability of randomly re-generating the same p or q may be considered acceptably small for many applications. For example, if n is 200 digits long, then the number of n/2 digit long primes is approximately 10⁹⁷ and accordingly the probability of re-generating the same prime is small. Therefore, for such applications, random generation of factors p and q each time a new n is to be produced may be a sufficient means to minimize the probability of using the same factor p and/or q more than once for encrypting the same password.

It is also possible that in a particular preferred embodiment there are more than one suitable function which can be used for the encryption, and that the encryption key includes the selected function definition, with other necessary elements either transmitted along with the encryption key or already available for use in calculation of the defined function.

For applications which may not have as stringent security requirements, another non-limiting possible encryption involves a permutation of characters (digits, letters, and/or special characters) included in a password. For example, assume the password is composed of the birth date (D₁D₂/M₁M₂/Y₁Y₂) of the user followed by a secret code (L₁L₂/R₁R₂) followed by the credit card number of the user (C₁ C₂ C₃ C₄ C₅ C₆ C₇ C₈ C₉ C₁₀ C₁₁ C₁₂ C₁₃ C₁₄ C₁₅ C₁₆). The encryption key can include for example instructions for exchanging the position of D₂ with the position of R₂ and the position of L₂ with M₁. For a further level of encryption, the encryption key can also include a function to be performed on the permuted characters. For example, the function can include selection of a subset of characters in the permuted password to obtain the final encrypted password. Other examples of functions which can be used in this type of encryption include, addition of selected characters, multiplication of selected characters, modulo (n) addition, and selection of n out of m characters.

For the sake of example, a preferred embodiment of the system of the invention will now be elaborated on. User terminal 112, identification center terminal 114, and optional intermediate service provider terminal 116 (FIG. 1) are configured to execute the authentication method, for example the steps illustrated in FIGS. 2, 3, and/or 4.

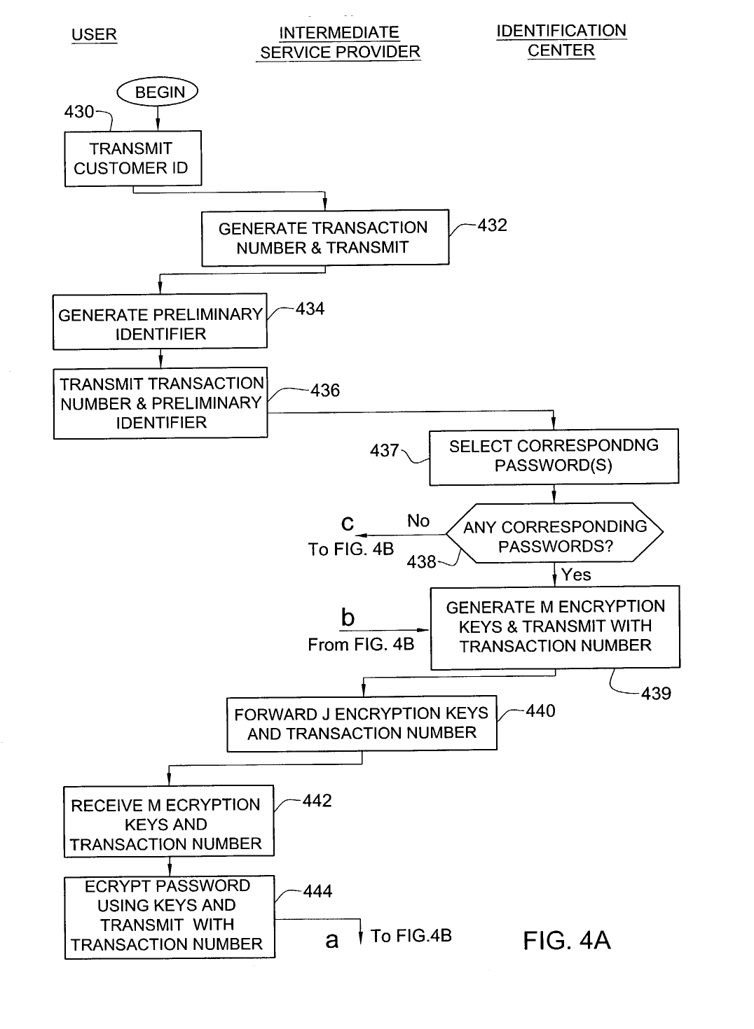

Refer to FIG. 5 which shows a preferred embodiment of identification center terminal 114. Identification center terminal includes a receiver 510 and a transmitter 512 (or a combination of the two) configured to receive and/or transmit via communication medium 110. Identification center terminal 114 also includes a storage element 514, for example a database, for storing user passwords. Also included in identification center terminal 114 is a simulator 516 configured to simulate the encryption on one or more passwords retrieved from storage 514. For example, if the encryption includes applying a function, simulator 516 is configured to calculate the function. In embodiments where identification center terminal 114 is configured to generate the encryption key, terminal 114 also includes an optional encryption key generator 520. For example, if the encryption key includes n and e for the function Y=X^{e}(mod n), then generator 520 generates appropriate n's and e's.

Also included in identification center terminal 114 is a comparator 518 configured to compare the simulated encrypted password(s) with the encrypted password received directly or indirectly from the user (here it is assumed for the sake of simplicity of explanation that only one encrypted password is received). For example, assuming the encryption results in a number, comparator 518 can calculate the percentage difference between each simulated encrypted password(s) and the received encrypted password. As another example, comparator 518 can compare the number of identical characters (in the same position) in each simulated encrypted password(s) with the received encrypted password. Typically although not necessarily the comparison results are sufficient to authenticate a user if one simulated encrypted password can be singled out as corresponding to the received encrypted password.

In one embodiment, as part of the comparison, a score is assigned to each simulated encrypted password and the simulated encrypted password with the best score, i.e. the closest match to the received encrypted password, is selected. (If there is more than one simulated encrypted password with the same best score, more rounds can be performed-see above). Continuing with the example of percentage difference, the comparison would typically but not necessarily cause the selection of the simulated encrypted password whose percentage difference is closest to zero. Continuing with the example of comparing individual characters in the encrypted password, the comparison would typically but not necessarily cause the selection of the simulated encrypted password with the most matching characters. It should be evident that if the preliminary identifier pinpoints only one password for encryption simulation, then that one password by definition has the best score, i.e. is the closest match and is therefore selected. The selected (best score) encrypted password is then evaluated to see if the selected encrypted password is close enough to the received encrypted password, where the definition of “close enough” depend on the particular embodiment. Again assuming a percentage difference comparison, in some cases only a percentage difference of zero (i.e. the received and selected encrypted passwords are identical) would be considered close enough and the comparison results sufficient to authenticate the user. In other cases, for example if security requirements are lower, a small non-zero percentage difference may be considered close enough. Assuming the character by character comparison, in some cases all characters would need to be identical for the selected encrypted password to be considered close enough whereas in other cases, a majority or an overwhelming majority of identical characters would be considered close enough.

In another non-limiting embodiment, as part of the comparison, all simulated encrypted passwords which are close enough matches with the received encrypted password are selected. Continuing with the example of percentage difference, the comparison would typically but not necessarily cause the selection of all simulated encrypted passwords with not more than a predetermined percentage difference level. The level would depend on the embodiment; in one case the definition of a close enough match may require a zero percentage difference (i.e. the received and selected encrypted passwords are identical) whereas in another case a match with a non zero percentage difference may also qualify as close enough. Continuing with the example of comparing individual characters in the encrypted password, the comparison would typically but not necessarily cause the selection of all simulated encrypted passwords whose number of matching characters is above a predetermined level. The level would depend on the embodiment; in one case the definition of a close enough match may require all identical characters whereas in another case a match with some non-identical characters may also qualify as close enough. If a single simulated encrypted password is selected as being a close enough match, then the comparison results are sufficient to authenticate the user. If more than one simulated encrypted password is selected as close enough matches, more rounds can be performed-see above.

It is also possible that the definition of “close enough” may vary based on the reliability and/or uniqueness of the preliminary identifier. For example, in a particular embodiment the requirements for being considered close enough may be less stringent when the preliminary identifier used corresponds to only one password than when the preliminary identifier used corresponds to a plurality of passwords, provided the preliminary identifier is considered reliable. A particular preliminary identifier may be considered reliable, for example, if it is difficult to fraudulently obtain that particular preliminary identifier.

In some preferred embodiments, identification center terminal 114 may have memory space and computation time requirements which affect the authentication process. For example, if the encryption used in an authentication process is computationally time consuming, then the preliminary identifier may be designed to correspond to only a small number of passwords on which the encryption is to be simulated. For example, assume that the number of passwords accessible to the identification center is 10⁸ (1/60^{th} of the current estimated world population of 6×10⁹). Assume also that a preliminary identifier of the user is composed of any four letters and any four digits . Therefore, the number of possible preliminary identifiers is 4.5*10⁹ (i.e. 26⁴*10⁴) . Even accounting for the unequal frequencies of the different letters, in this example the number of corresponding passwords for any given preliminary identifier would be small (and often only one) As another example, buffers can be used at the identification center terminal 114 to ease computation time requirements, for example for buffering n's as was discussed above.

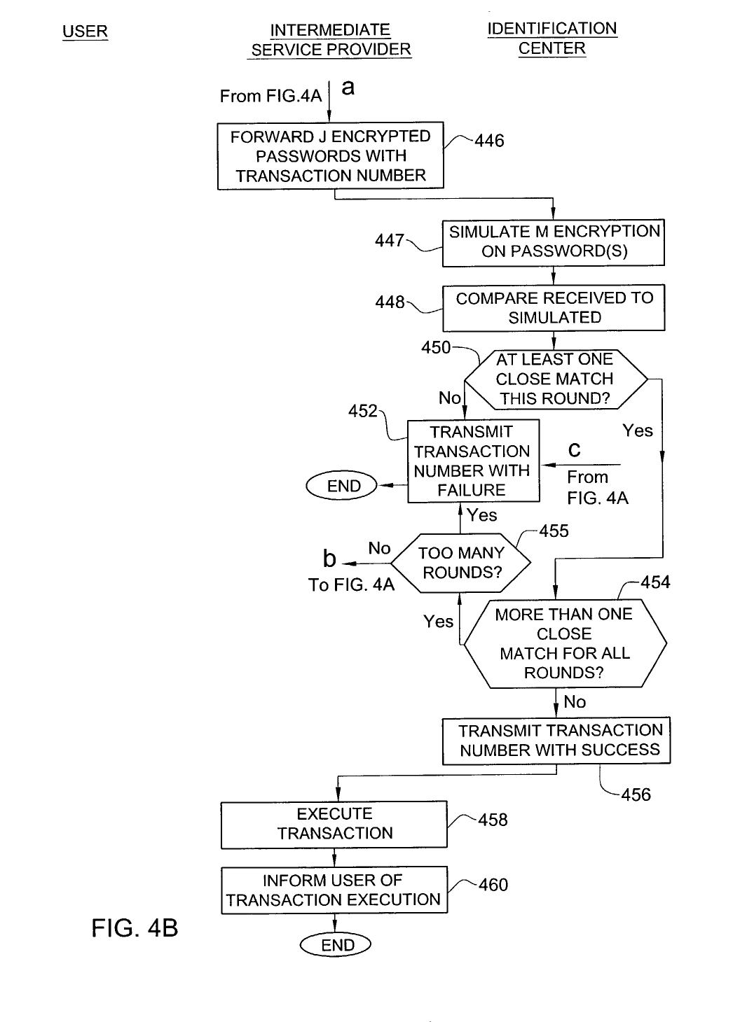

FIG. 6 shows a preferred embodiment of user terminal 112. User terminal 112 include an encrypter 610 configured to encrypt the password of the user. For example if the encryption includes applying a function, encrypter 610 is configured to calculate the function. User terminal also includes a transmitter 612 and a receiver 614 (or a combination of the two) configured to transmit and/or receive via communication medium 110. Computation time and memory space requirements of user terminal 112 may impact the authentication process. For example if in a particular application, the tasks to be performed by the user terminal are desired to be minimized, then the tasks assigned to user terminal 112 may be limited to transmitting, receiving, and encrypting.

It is also possible that computation time and memory space requirements on one or more of terminals 112, 116 and 114 may affect the remaining terminals. For example, in order to ease the computation required by the identification center terminal 114 and/or user terminal 112, intermediate service provider terminal 116 may be used and assigned tasks more computationally intensive than forwarding data between the other terminals 112 and 114. As another example, user terminal 112 may keep a record of the recent history of encryption keys in order to lower the computation time requirements of the identification center terminal 114 during the encryption key transmission process, as was discussed above.

Identification of the authenticated user may also be desirable in some embodiments. In the context of the description above, it should be understood that identification of the authenticated user may be accomplished in different ways depending on the embodiment. For example, in embodiments where a unique preliminary identifier is used, the identification center is in possession of the identity of the user once the identification center has received the preliminary identifier. Continuing with the example, if the preliminary identifier is the credit card number of the user, then if the password corresponding to the credit card number preliminary identifier is matched as described above with reference to various embodiments of the invention, the authenticated user can be identified as the holder of the corresponding credit card. As another example, in embodiments where the password is at least partly composed of personal identification numbers, then once the password has been matched as described above with reference to various embodiments of the invention, the identification center may extract one or more personal identification numbers in the password and thereby identify the authenticated user. As another example, in some embodiments the identification center may have access to identifying information corresponding to each accessible password and can use the identifying information corresponding to the matched password to identify the authenticated user. As another example, in some embodiments identification of the authenticated user may be performed by the intermediate service provider (and the identification center does not need to identify the authenticated user), based on for example the preliminary identifier, customer identifier, and/or transaction number, etc.

In other embodiments, identification of the authenticated user may not be required. For example, in one embodiment an identification center such as a credit card company may have access to the passwords of all credit card holders and allow any authenticated user to perform a certain action such as for example accessing the credit card web site. As another example, in one embodiment an intermediate service provider may target a particular age-group for a free gift, and any authenticated user with a given birth-year (where the birth year is used as a preliminary identifier) would be eligible.

In the context of the description above, it should also be understood that authentication of the user as described above with reference to various embodiments of the current invention, may in some embodiments also lead to authentication of items, actions, and/or data related to the authenticated user. For example, if a user is allowed to log on upon authentication as described above with reference to various embodiments of the current invention, subsequent actions performed by the user and/or data transmitted by the user while logged on may be accepted as authentic. As another example, a bank withdrawal from the account of a user authenticated as described above with reference to various embodiments of the current invention may be accepted as authentic. As another example, authentication of the user as described above with reference to various embodiments of the current invention may allow an identification card such as a social security card in the name of the user to be accepted as authentic. As another example, if a user is allowed access into a physical restricted area upon authentication as described above with reference to various embodiments of the current invention, subsequent actions by the user while in the restricted area may be accepted as authentic.

In another aspect of the invention, user terminal 112 and identification center terminal 114 may not be connected by a communication medium. Identification center terminal 114 in this aspect of the invention may exclude receiver 510 and transmitter 512, and instead include an input 702 and an output 704. In this aspect of the invention, user terminal 112 may exclude transmitter 612 and receiver 614, and instead include an input 802 and an output 804. For example, identification center terminal 114 may be located at the physical entrance to a restricted place and user terminal 112 may be a portable device carried by the user to the physical entrance. Continuing with the example, instead of transmissions and receipts via a communication medium as described above, the user (or a proxy) may pass the information between the two terminals 112 and 114. For the ease of understanding, an example of part of the process is now described. Identification center terminal 114 outputs the encryption key via output 702, for example a display. The user obtains the encryption key from output 702, for example by reading the display. The user then inputs the encryption key into input 802 of user terminal 112, for example by entering the encryption key via a keyboard or stylus. User terminal 112 performs the encryption and outputs the encrypted password via output 804, for example a display. The user obtains the encrypted password from output 804, for example by reading the display and inputs the encrypted password into input 702 of identification center terminal 114, for example by entering the characters through a keypad. Identification center terminal 114 then simulates the encryption and compares the simulated encrypted passwords to the entered encrypted password and if the results are sufficient, authenticates the user.

It will also be understood that the system according to the invention may be a suitably programmed computer. Likewise, the invention contemplates a computer program being readable by a computer for executing the method of the invention. The invention further contemplates a machine-readable memory tangibly embodying a program of instructions executable by the machine for executing the method of the invention.

While the invention has been described with respect to a limited number of embodiments, it will be appreciated that many variations, modifications and other applications of the invention may be made.

In the method claims that follow, alphabetic characters and Roman numerals used to designate claim limitations are provided for convenience only and do not imply any particular order of performing the limitations.

1. A method for authenticating a user by an identification center over a communication medium, comprising:
(a) sending via the communication medium an encryption key including at least one element which is required for encrypting a password of the user, wherein said password is presumed to be accessible to the user and to the identification center;
(b) the user encrypting said password using at least said encryption key;
(c) the user sending said encrypted password via the communication medium;
(d) the identification center receiving said encrypted password via the communication medium;
(e) the identification center simulating said encrypting on at least one of the passwords accessible to the identification center;
(f) the identification center comparing said at least one simulated encrypted password to said received encrypted password; and
(g) if results of said comparing are sufficient, the identification center sending via the communication medium an indication that the user has been authenticated.

2. The method of claim 1, wherein (e) includes: for each said at least one password, the identification center simulating said encrypting on said each password using at least said encryption key, thereby creating at least one simulated encrypted password, and wherein (f) includes: the identification center associating each simulated encrypted password with a score indicating the matching degree between said received encrypted password and the respective simulated encrypted password; and the identification center selecting any simulated encrypted password having scores at least as good as a predetermined level; and wherein (g) includes: if in (f) a single simulated encrypted password is selected as having a score at least as good as said predetermined level, the identification center sending an indication that comparison results are sufficient to authenticate the user via said communication medium.

3. The method of claim 2, wherein a score as good as said predetermined level is indicative of a simulated encrypted password associated with said score being identical to said received encrypted password.

4. The method of claim 1, further comprising:
(h) the identification center receiving a preliminary identifier of the user, the identification center associating said preliminary identifier with less than all passwords accessible to the identification center, whereas said simulation in (e) on at least one password is performed on said associated less than all passwords.

5. The method of claim 4, wherein said preliminary identifier is associated with only one password, and said simulation in (e) on at least one password is performed on said only one password.

6. The method of claim 4, wherein said preliminary identifier includes at least one from a group including at least: a year of birth of the user, all digits in a national identification number of a user, less than all digits in a national identification number of a user, all digits in a social security number of a user, less than all digits in a social security number of a user, an expiry month and year of the user credit card, date of birth of a user, a name of the user, a personal identification number (PIN) of a user, maiden name of mother of user, city of birth of user, all digits in a credit card number of the user, less than all digits in a credit card number of the user, a predetermined number of digits along with a predetermined number of letters, all characters in a passport number, less than all characters in a passport number, all digits in a driver's license number, less than all digits in a driver's license number, all digits in a telephone number, less than all digits in a telephone number, all characters in an address, less than all characters in an address, and less than all characters in said password of the user.

7. The method of claim 4, wherein said preliminary identifier is generated by the user.

8. The method of claim 4, wherein said preliminary identifier is generated by an intermediate service provider based on enrollment data previously received from the user.

9. The method of claims 4, wherein said preliminary identifier is not associated with any passwords accessible to the identification center and therefore authentication of the user fails prior to (e).

10. The method of claim 1, wherein said simulation in (e) on at least one password is performed on all passwords accessible to the identification center.

11. The method of claim 1, wherein said (a) includes: the identification center generating said encryption key and sending said encryption key to the user via the communication medium.

12. The method of claim 1, wherein said (a) includes: the user generating said encryption key and sending said encryption key to the identification center.

13. The method of claim 1, wherein (a) includes: an intermediate service provider generating said encryption key and sending said encryption key to the user and to the identification center.

14. The method of claim 1, wherein said encryption includes applying a function.

15. The method of claim 14, wherein said function is a one way function.

16. The method of claim 14, wherein said function is Y equals X^{e}(mod n).

17. The method of claim 16, wherein said at least one element in said sent encryption key includes n and e and said password is substituted for X when calculating Y.

18. The method of claim 1, wherein user authentication is desired prior to an intermediate service provider executing a transaction, further comprising: (i) an intermediate service provider generating a transaction identifier, said transaction identifier being used to distinguish a transmission over the communication medium relating to said transaction.

19. The method of claim 1, wherein (c) includes: the user sending to an intermediate service provider said encrypted password and said intermediate service provider sending said encrypted password to the identification center, and wherein (d) includes: the identification center receiving said encrypted password from said intermediate service provider, and wherein (g) includes: if said comparison results are sufficient, the identification center providing to said intermediate service provider an indication that said comparison results are sufficient.

20. The method of claim 19, wherein said indication of sufficiency provided by the identification center to said intermediate service provider includes a transaction identifier generated by said intermediate service provider, thereby enabling said intermediate service provider to execute a transaction for which authentication of the user is desired prior to execution.

21. The method of claim 1, wherein (c) includes: the user sending at least two encrypted passwords, at least one of said at least two to the identification center and at least one other of said at least two to an intermediate service provider, and wherein (d) includes: the identification center receiving said at least two encrypted passwords, said at least one of said at least two from the user and said at least one other of said at least two from said intermediate service provider, and wherein (e) and (f) are performed for each of said at least two received encrypted passwords, and wherein (g) includes: if all comparison results, associated with said at least two encrypted passwords are sufficient, the identification center providing an indication to said intermediate service provider and an indication to the user that said all comparison results are sufficient.

22. The method of claim 21, wherein said indication of sufficiency provided by the identification center to said intermediate service provider includes a transaction identifier generated by said intermediate service provider, thereby enabling said intermediate service provider to execute a transaction for which authentication of the user is desired prior to execution.

23. The method of claim 1, further comprising: (j) if said comparison results of (g) are insufficient, activating an action selected from a group that includes: (1) declaring failure, and (2) providing a new encryption key that includes at least one different element as stipulated in (a); and re-executing (a) to (g).

24. The method of claim 1, wherein said password includes at least one predetermined user identification numbers selected from a group including at least: at least part of a credit card number of the user, at least part of a birth date of the user, at least part of a passport number of the user, at least part of a driving license number of the user, at least part of an address of the user, at least part of a phone number of the user, at least part of a social security number of the user, and at least part of a national identification number of the user.

25. The method of claim 1, wherein prior to (b), the user checks the validity of said encryption key sent in (a) and if invalid, (a) is repeated with a different encryption key.

26. A system for authenticating a user, through a user terminal, by an identification center, through an identification center terminal, the user terminal connected via a communication medium with the identification center terminal, the identification center terminal comprising:
(a) a receiver configured to receive an encrypted password via the communication medium from the user terminal or from an intermediate service provider terminal which is also connected via the communication medium, said encrypted password having been encrypted by the user terminal using an encryption key transmitted via the communication medium;
(b) a storage configured to store passwords;
(c) a simulator configured to simulate said encryption on at least one password from said storage;
(d) a comparator configured to compare said at least one simulated encrypted password to said received encrypted password; and
(e) a transmitter configured to transmit via the communication medium if said comparison results are sufficient to authenticate the user an indication that said comparison results are sufficient.

27. A system for authenticating a user through a user terminal, by an identification center, through an identification center terminal, the user terminal connected via a communication medium with the identification center terminal, the user terminal comprising:
(a) an encrypter configured to encrypt a password using at least an encryption key transmitted via the communication medium;
(b) a transmitter configured to transmit said encrypted password to an intermediate service provider terminal which is also connected via the communication medium for transfer to the identification center terminal, or to transmit to the identification center terminal; and
(c) a receiver configured to receive, if results of comparing said sent encrypted password with an encrypted password simulated by the identification center terminal are sufficient to authenticate the user, an indication that comparison results are sufficient.

28. A method for authenticating a user by an identification center over a communication medium, comprising:
(a) the identification center sending via the communication medium an encryption key including at least one element which is required for encrypting a password of the user;
(b) the identification center receiving an encrypted password via the communication medium, wherein encryption of said password was performed by the user using at least said encryption key;
(c) the identification center simulating said encryption using at least said encryption key on each of less than all passwords accessible to the identification center, said less than all are associated with a preliminary identifier received from the user;
(d) the identification center comparing said simulated encrypted less than all passwords to said received encrypted password; and
(e) if comparison results of said comparing are sufficient to authenticate the user, the identification center sending an indication that said comparison results are sufficient to authenticate the user via said communication medium.

29. A method for authenticating a user by an identification center over a communication medium, comprising:
(a) the identification center receiving a preliminary identifier of the user, the identification center associating said preliminary identifier with less than all passwords accessible to the identification center;
(b) the identification center sending via the communication medium an encryption key including at least an n for applying a function Y=X^{e}(mod n) to a password of the user, said user password including at least part of at least one user identification number;
(c) if said n differs from all recently sent n to the user, the identification center receiving an encrypted password via the communication medium signifying an approval of said encryption key, wherein encryption of said password was performed by the user using at least said approved encryption key;
(d) if said ‘n’ is identical to a recently sent ‘n’ to the user, the identification center receiving a disapproval of said encryption key and repeating (b), (c) and (d);
(e) the identification center simulating said approved encryption using at least said approved encryption key on each of said less than all passwords;
(f) the identification center comparing said simulated encrypted less than all passwords to said received encrypted password; and
(g) if comparison results of said comparing are sufficient to authenticate the user, the identification center sending an indication that said comparison results are sufficient to authenticate the user via said communication medium.

30. A system for authenticating a user through a user terminal, by an identification center, through an identification center terminal, the user terminal connected via a communication medium with the identification center terminal, the identification center terminal comprising:
(a) a receiver configured to receive a preliminary identifier of the user and an encrypted user password via the communication medium from the user terminal or from an intermediate service provider terminal which is also connected via the communication medium, said encrypted password having been constructed by the user terminal using at least an encryption key originating from the identification center and transmitted via the communication medium;
(b) a storage configured to store at least said password;
(c) a simulator configured to simulate said encryption using at least said encryption key on each password in said storage which is associated with said preliminary identifier;
(d) a comparator configured to compare each simulated encrypted password and said received encrypted password; and
(e) a transmitter configured to transmit via the communication medium if results of said comparator are sufficient to authenticate the user an indication that said comparison results are sufficient.

31. A system for authenticating a user through a user terminal, by an identification center, through an identification center terminal, the user terminal connected via a communication medium with the identification center terminal, the identification center terminal comprising:
(a) a receiver configured to receive a preliminary identifier of the user and an encrypted password via the communication medium from the user terminal or from an intermediate service provider terminal which is also connected via the communication medium, said encrypted password having been constructed by the user terminal using at least an encryption key originating from the identification center and transmitted via the communication medium, said encryption key including at least an n for applying a function Y equals X^{e}(mod n) to said password in order to obtain said encrypted password, said password including at least at least part of at least one user identification number;
(b) a storage configured to store at least said password;
(c) a simulator configured to simulate said encryption using at least said encryption key on each password in said storage which is associated with said preliminary identifier;
(d) a comparator configured to compare each simulated encrypted password and said received encrypted password; and
(e) a transmitter configured to transmit via the communication medium if results of said comparing are sufficient to authenticate the user an indication that said comparing results are sufficient.

32. A method for authenticating a user by an identification center, comprising:
(a) the identification center outputting an encryption key including at least one element which is required for encrypting a password of the user, wherein said password is presumed to be accessible to the user and to the identification center;
(b) the user encrypting said password using at least said encryption key;
(c) the user inputting said encrypted password to the identification center;
(d) the identification center simulating said encrypting on at least one of the passwords accessible to the identification center;
(e) the identification center comparing said at least one simulated encrypted password to said inputted encrypted password; and
(f) if results of said comparing are sufficient, the identification center outputting an indication that the user has been authenticated.

33. A system for authenticating a user, through a user terminal, by an identification center, through an identification center terminal, the identification center terminal comprising:
(a) an input configured to receive an encrypted password, said encrypted password having been encrypted by the user terminal using an encryption key outputted by the identification center terminal;
(b) a storage configured to store passwords;
(c) a simulator configured to simulate an encryption on at least one password from said storage;
(d) a comparator configured to compare said at least one simulated encrypted password to said received encrypted password; and
(e) an output configured to output if said comparison results are sufficient to authenticate the user an indication that said comparison results are sufficient.

34. A system for authenticating a user through a user terminal, by an identification center, through an identification center terminal, the user terminal comprising:
(a) an encrypter configured to encrypt a password using at least an encryption key outputted by the identification center terminal;
(b) an output configured to output said encrypted password; and
(c) an input configured to receive, if results of comparing said outputted encrypted password with an encrypted password simulated by the identification center terminal are sufficient to authenticate the user, an indication that comparison results are sufficient, and configured to receive said encryption key.

35. A computer program product that includes a computer storage medium for storing a computer code portion for executing b and c of method claim 1.

36. A computer program product that includes a computer storage medium for storing a computer code portion for executing d, e, f, and g of method claim 1.

37. A computer program product that includes a computer storage medium for storing a computer code portion for executing the method of claim 28.

38. A computer program product that includes a computer storage medium for storing a computer code portion for executing the method of claim 29.

39. A computer program product that includes a computer storage medium for storing a computer code portion for executing b and c of method claim 32.

40. A computer program product that includes a computer storage medium for storing a computer code portion for executing a, d, e, and f of method claim 32.
